(19) United States
(12) Patent Application Publication
(10) Pub. No.: US 2014/0215920 A1
(43) Pub. Date: Aug. 7, 2014

(54) HYDROPONIC APPARATUS AND COLLECTING DEVICE THEREOF

(71) Applicant: CHUNGHWA PICTURE TUBES, LTD, Padeh City (TW)

(72) Inventors: Chou-Chiang KUO, New Taipei City (TW); Min-Chung CHENG, New Taipei City (TW); Che-Wei CHANG, Daxi Township (TW)

(21) Appl. No.: 13/915,074

(22) Filed: Jun. 11, 2013

(30) Foreign Application Priority Data
Feb. 5, 2013 (TW) 102202460

(51) Int. Cl. A01G 31/02; A01G 9/02

(52) U.S. Cl. CPC A01G 31/02; A01G 9/027
USPC 47/62 R; 47/65.5; 47/65.7

(57) ABSTRACT

A hydroponic apparatus and a collecting device are provided. The collecting device includes at least two hollow containers, a connection part and two handles. Each of the hollow containers has an interior adapted to be stuffed with a porous adsorption material. The connection part is adapted to physically connecting one of the hollow containers to next one of the hollow containers in order. The two handles are disposed on the outermost two of the hollow containers.

### CROSS-REFERENCE TO RELATED APPLICATION

This application claims the benefit of Taiwan Patent Application No. 102202460, filed on Feb. 5, 2013, which is hereby incorporated by reference for all purposes as if fully set forth herein.

### BACKGROUND OF THE INVENTION

1. Field of Invention

This invention relates to a collecting device, and more particularly to a collecting device for applying to a hydroponic apparatus.

2. Related Art

In order to avoid the invasion of various pests and diseases, vegetables planted in the soil can be generally sprayed by a lot of pesticide before the harvest of the vegetables. However, after a consumer purchases the vegetables, if the clean of the vegetables is not enough and the consumer eats pesticide residues, a body the consumer can easily be injured. Hydroponic crops have health and safety without pesticides and fertilizers, and thus the hydroponic crops are gradually favored by the majority of consumers in recent years. Also, the hydroponic crops are gradually become crops in the mainstream market, because of the characteristics of free soil tillage and planted convenience.

However, the number of conventional collecting devices for the hydroponic crops is designed to be a plurality, and the collecting devices are tightly arranged in a nutrient solution tank. Thus, roots of the hydroponic crops are easily intertwined one another so as not to easily collect the hydroponic crops. Furthermore, a collector must remove the collecting devices respectively from the nutrient solution tank, and then collects the hydroponic crops form each collecting device.

Accordingly, there exists a need for a collecting device capable of solving the above-mentioned problems.

### SUMMARY OF THE INVENTION

It is an objective of the present invention to provide a collecting device and a hydroponic apparatus, when the hydroponic crops are densely grown in the collecting device of the present invention, it can be possibly decreased that roots of hydroponic crops are intertwined one another.

It is another objective of the present invention to provide a collecting device, when the hydroponic crops are collected, the hollow containers of the collecting device can be drawn out from the positioning holes by directly using the handles of the collecting device, thereby conveniently collecting many hydroponic crops at the same time.

In order to achieve the objective, the present invention provides a collecting device including at least two hollow, a connection part and two handles. Each of the hollow containers has an interior adapted to be stuffed with a porous adsorption material. The connection part is adapted to physically connecting one of the hollow containers to next one of the hollow containers in order. The two handles are disposed on the outermost two of the hollow containers.

In order to achieve the objective, the present invention further provides a hydroponic apparatus including a nutrient solution tank, a positioning plate and a collecting device. The nutrient solution tank includes a tank having an accommodation space for accommodating a nutrient solution which makes a hydroponic crop grown. The positioning plate includes a plurality of positioning holes, disposed in the tank of the nutrient solution tank, and located above the nutrient solution. The collecting device includes at least two hollow containers, a connection part and two handles. Each hollow container includes a lower portion, wherein the hollow containers are disposed in the positioning holes of the positioning plate respectively, there is a distance between a bottom surface of the lower portions of the hollow containers and a bottom portion of the nutrient solution tank, and the hollow container having an interior adapted to be stuffed with a porous adsorption material. The connection part is adapted to physically connecting one of the hollow containers to next one of the hollow containers in order. The two handles disposed on the outermost two of the hollow containers.

Thus, the present invention has the following features. The hollow containers of the collecting device can be drawn out from the positioning holes by directly using the handles of the collecting device, thereby conveniently collecting many hydroponic crops at the same time so as to save manpower and time.

In order to make the aforementioned and other objectives, features and advantages of the present invention comprehensible, embodiments are described in detail below with reference to the accompanying drawings.

### BRIEF DESCRIPTION OF THE DRAWINGS

FIG. 1a is a schematic perspective view of a hollow container of a collecting device according to an embodiment of the present invention;

FIG. 1b is a schematic cross-sectional view of a hollow container of a collecting device according to an embodiment of the present invention;

FIG. 2 is a schematic cross-sectional view of a collecting device according to an embodiment of the present invention;

FIG. 3 is a schematic top view of a hydroponic apparatus according to an embodiment of the present invention; and

FIG. 4 is a schematic cross-sectional view of a hydroponic apparatus along line AA′ of FIG. 3,

The present invention will become more fully understood from the detailed description given herein below for illustration only, and thus are not limitative of the present invention, and wherein:

### DETAILED DESCRIPTION OF THE INVENTION

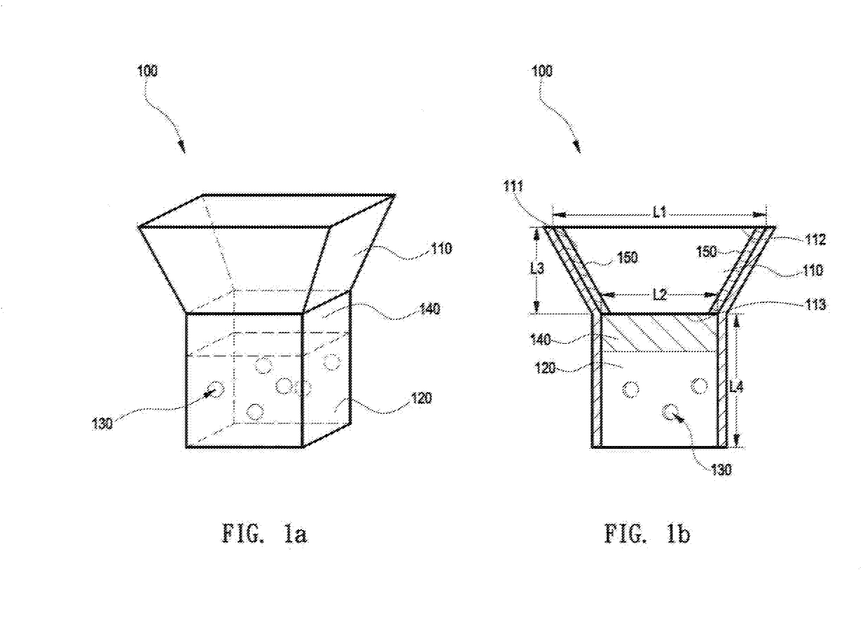

FIG. 1a is a schematic perspective view of a hollow container of a collecting device according to an embodiment of the present invention. FIG. 1b is a schematic cross-sectional view of a hollow container of a collecting device according to an embodiment of the present invention. The hollow container 100 has an interior adapted to be stuffed with a porous adsorption material 140, wherein hydroponic crops are grown in the porous adsorption material 140. The porous adsorption material 140 can be foam material, artificial foam material, artificial sponge material, cotton material, etc. The hollow container 100 includes a funneled portion 110 and a lower portion 120. The funneled portion 110 is physically connected to the lower portion 120. An inner surface 111 of the funneled portion 110 can be provided with a refection material 150 for increasing a utility rate of the light. The refection material 150 can be aluminum foil or tin foil. The shape of the funneled portion 110 can be circular or square. In this embodiment, the shape of the funneled portion 110 is square, for example.

The funneled portion 110 has a top surface 112, whose diameter L1 can be 5.5 centimeters. The funneled portion 110 has a bottom surface 113, whose diameter L2 can be 2.6 centimeters, The height L3 of the funneled portion 110 can be between 3 and 4 centimeters. The depth L4 of the lower portion 120 can be between 6 and 9 centimeters. The lower portion 120 includes at least one side surface and a plurality of through holes 130 formed in the side surface, wherein the diameters of the through holes 130 can be between 0.3 and 0.7 centimeter.

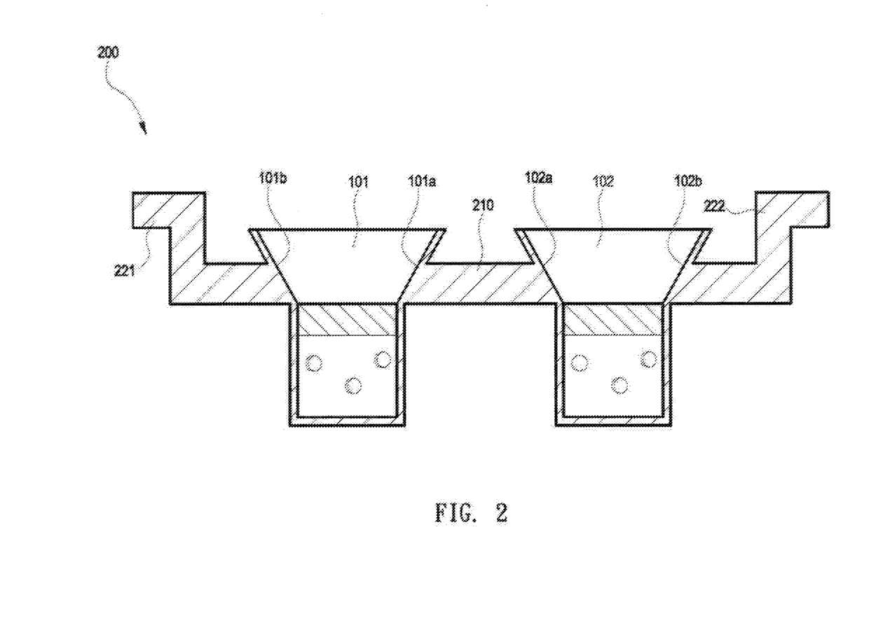

As shown in FIG. 2, it is a schematic cross-sectional view of a collecting device according to an embodiment of the present invention. The collecting device 200 includes at least two hollow containers, a connection part 210 and two handles. The two hollow containers are the above-mentioned hollow container 100 of the present invention. In order to conveniently describe, the two hollow containers shown in FIG. 2 are the first hollow container 101 and the second hollow container 102, and the two handles shown in FIG. 2 are the first handle 221 and the second handle 222. The connection part 210 is adapted to physically connecting one of the hollow containers to next one of the hollow containers in order. In other words, the connection part 210 is physically connected between an inner side 101a of the first hollow container 101 and an inner side 102a of the second hollow container 102. The two handles are disposed on the outermost two of the hollow containers. In other words, the first handle 221 is disposed on an outer side 101b of the first hollow container 101, and the second handle 222 is disposed on an outer side 102b of the second hollow container 102. The first hollow container 101, the second hollow container 102, the connection part 210, the first handle 221 and the second handle 222 can be made of plastic material, and can be integrally formed by an injection molding process. Then, the through holes 130 are formed in the side surface of the lower portion 120 of the hollow container 100 (shown in FIG. 1a) by a boring process.

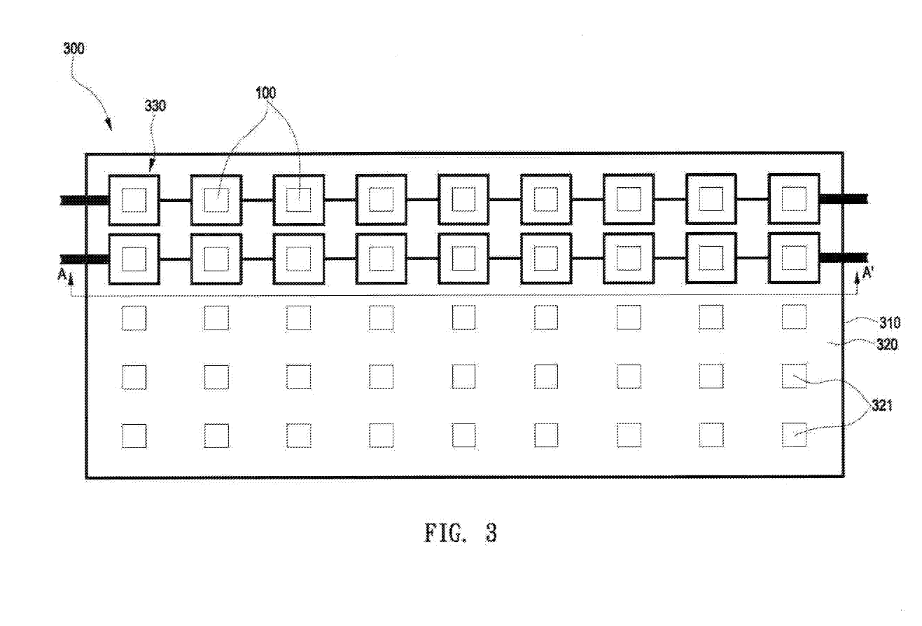

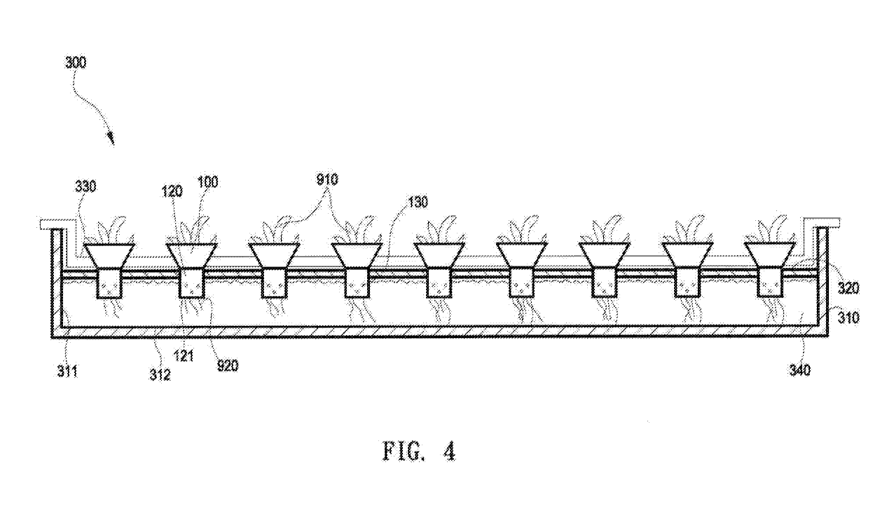

FIG. 3 is a schematic top view of a hydroponic apparatus according to an embodiment of the present invention. FIG. 4 is a schematic cross-sectional view of a hydroponic apparatus along line AA′ of FIG. 3. The hydroponic apparatus 300 includes a nutrient solution tank 310, a positioning plate 320 and a collecting device 330. The nutrient solution tank 310 includes a tank 311 having an accommodation space for accommodating a nutrient solution 340 which can make hydroponic crops grown. The positioning plate 320 includes a plurality of positioning holes 321. The positioning plate 320 is disposed in the tank 311 of the nutrient solution tank 310, and located above the nutrient solution 340. The collecting device 330 can be the collecting device 200 shown in FIG. 2. The hollow containers 100 of the collecting device 330 are disposed in the positioning holes 321 of the positioning plate 320 respectively. There is a distance between a bottom surface 121 of the lower portions 120 of the hollow containers 100 and a bottom portion 312 of the nutrient solution tank 310, wherein the distance is approximately between 1 and 2, whereby roots 920 of hydroponic crops 910 can be conveniently grown and freely extended, and cannot be intertwined one another.

The hydroponic apparatus 300 is used, the nutrient solution 340 is put into the tank 311 of the nutrient solution tank 310, but the height of the nutrient solution 340 cannot exceed the location of the positioning plate 320. The lower portions 120 of the hollow containers 100 are soaked in the nutrient solution 340, and thus the through holes 130 formed in the side surface of the lower portions 120 can increase the uniformity and the oxygen content the flow of the nutrient solution 340.

Thus, the present invention has the following features:

1. The collecting device of the present invention can be made of plastic material and formed by a traditional process. According to leafy vegetables which need the short-term growth time, the collecting device is firstly installed in the positioning holes, and the foam material where young sprouts are grown in is inserted into the hollow containers the collecting device. When the hydroponic crops are collected, the hollow containers of the collecting device can be drawn out from the positioning holes by directly using the handles of the collecting device, thereby conveniently collecting many hydroponic crops at the same time so as to save manpower and time.

2. The lower portions of the hollow containers are soaked in the nutrient solution, and thus the through holes formed in the side surface of the lower portions can increase the uniformity and the oxygen content of the flow of the nutrient solution. Furthermore, when the hydroponic crops are densely grown in the collecting device of the present invention, it can be possibly decreased that the roots of the hydroponic crops are intertwined one another. When the hydroponic crops are collected, the collecting device of the present invention can prevent the broken roots of the hydroponic crops from remaining in and difficultly cleaning the tank.

To sum up, the implementation manners or embodiments of the technical solutions adopted by the present invention to solve the problems are merely illustrative, and are not intended to limit the scope of the present invention. Any equivalent variation or modification made without departing from the scope or spirit of the present invention shall fall within the appended claims of the present invention.

What is claimed is:

1. A collecting device comprising:
at least two hollow containers, wherein each of the hollow containers has an interior adapted to be stuffed with a porous adsorption material;
a connection part adapted to physically connecting one of the hollow containers to next one of the hollow containers in order; and
two handles disposed on the outermost two of the hollow containers.

2. The collecting device as claimed in claim 1, wherein the hollow container comprises a funneled portion having an inner surface provided with a refection material.

3. The collecting device as claimed in claim 2, wherein the refection material is aluminum foil or tin foil.

4. The collecting device as claimed in claim 1, wherein the hollow container comprises a lower portion comprising at least one side surface and a plurality of through holes formed in the side surface, and the diameters of the through holes are between 0.3 and 0.7 centimeter.

5. The collecting device as claimed in claim 1, wherein the hollow container comprises a lower portion, and the depth of the lower portion is between 6 and 9 centimeters.

6. The collecting device as claimed in claim 1, wherein the hollow containers, the connection part and the handles are made of plastic material, and are integrally formed.

7. The collecting device as claimed in claim 1, wherein a hydroponic crop is grown in the porous adsorption material

8. The collecting device as claimed in claim 1, wherein the porous adsorption material is foam material, artificial foam material, artificial sponge material or cotton material.

9. A hydroponic apparatus comprising:
a nutrient solution tank comprising a tank having an accommodation space for accommodating a nutrient solution which makes a hydroponic crop grown;
a positioning plate comprising a plurality of positioning holes, disposed in the tank of the nutrient solution tank, and located above the nutrient solution; and
a collecting device comprising:
at least two hollow containers, each comprising a lower portion, wherein the hollow containers are disposed in the positioning holes of the positioning plate respectively, there is a distance between a bottom surface of the lower portions of the hollow containers and a bottom portion of the nutrient solution tank, and the hollow container having an interior adapted to be stuffed with a porous adsorption material;
a connection part adapted to physically connecting one of the hollow containers to next one of the hollow containers in order; and
two handles disposed on the outermost two of the hollow containers.

10. The hydroponic apparatus as claimed in claim 9, wherein the hollow container comprises a funneled portion having an inner surface provided with a refection material.

11. The hydroponic apparatus as claimed in claim 10, wherein the refection material is aluminum foil or tin foil.

12. The hydroponic apparatus as claimed in claim 9, wherein the lower portion comprises at least one side surface and a plurality of through holes formed in the side surface, and the diameters of the through holes are between 0.3 and 0.7 centimeter.

13. The hydroponic apparatus as claimed in claim 9, wherein the depth of the lower portion is between 6 and 9 centimeters.

14. The hydroponic apparatus as claimed in claim 9, wherein the hollow containers, the connection part and the handles are made of plastic material, and are integrally formed.

15. The hydroponic apparatus as claimed in claim 9, wherein the hydroponic crop is grown in the porous adsorption material.

16. The hydroponic apparatus as claimed in claim 9, wherein the porous adsorption material is foam material, artificial foam material, artificial sponge material or cotton material.
